(19) United States
(12) Patent Application Publication
(10) Pub. No.: US 2011/0311338 A1
(43) Pub. Date: Dec. 22, 2011

(54) CYLINDRICAL BALE TRAILER

(76) Inventors: Ronald D. Patrick, Mounds, OK (US); Jerrod W. Latta, Glenpool, OK (US)

(21) Appl. No.: 13/162,693

(22) Filed: Jun. 17, 2011

Related U.S. Application Data
(60) Provisional application No. 61/355,902, filed on Jun. 17, 2010.

(51) Int. Cl. A01D 90/00; B60P 3/00; B60P 1/18

(52) U.S. Cl. 414/24.5

(57) ABSTRACT

A cylindrical bale trailer for transporting cylindrical bales of crop material, such as hay, cotton and the like, from one location to another comprising a pair of elongate side frame rails in substantially parallel arrangement, being spaced apart at a distance less than the diameter of a cylindrical bale, and a generally arcuate overhead axle substantially perpendicular to the side frame rails and having each end respectively attached to one of the side frame rails. A wheel and brake assembly is operatively attached to each of the side frame rails adjacent the overhead axle, and a hydraulic lift assembly is operatively connected to each of the side frame rails and the wheel and brake assembly for selectively raising and lowering the cylindrical bale trailer during loading and unloading procedures. In cooperation with the overhead axle, a front frame rail maintains the side frame rails in parallel relation. A hitch assembly, such as a standard bumper hitch, a hydraulically-actuated bumper assembly, or a gooseneck hitch assembly, extends forwardly to attach the cylindrical bale trailer to a prime mover.

### CROSS-REFERENCE TO RELATED APPLICATIONS

This application claims the benefit of U.S. Provisional Application No. 61,355,902, filed Jun. 17, 2010, which is herein incorporated by reference.

### BACKGROUND OF THE INVENTION

1. Field of the Invention

This invention relates generally to a cylindrical bale trailer for transporting cylindrical bales of a crop material, such as hay, cotton and the like, from one location to another, and more particularly to a cylindrical bale trailer for hauling cylindrical bales that is hydraulically operated for raising and lowering the cylindrical bale trailer during the loading and unloading procedures.

2. Description of the Related Art

It is common place to bind crop materials, such as hay, cotton and the like, in cylindrical bales through the use of automated baling equipment. These cylindrical bales are normally left in the field by the baling equipment and must be picked up later for movement to a desired storage site or the like. The bales are large and heavy, typically weighting about 800 to 2500 pounds per bale, with a diameter of about six (6) feet and a length of about four (4) or five (5) feet, and are thus too large and heavy to be manually handled. Typically, a farmer may use a tractor with a front end loader to pick up the bales, one at a time, and individually haul them to the desired field for feeding of the livestock. This process must be repeated a number of times until all the livestock is fed but the desired field for feeding may be located a mile or more away. As a result, livestock feeding can be a very-time consuming and cost intensive process.

It is therefore desirable to provide a cylindrical bale trailer that provides efficient and easy means for transporting cylindrical bales of crop material, such as hay, cotton and the like, from one location to another.

It is further desirable to provide a cylindrical bale trailer that easily and rapidly loads, unloads and transports heavy cylindrical bales.

It is still further desirable to provide a cylindrical bale trailer capable of collecting and transporting more than one cylindrical bale in longitudinal sequence.

It is yet further desirable to provide a cylindrical bale trailer that is hydraulically operated to efficiently and effectively control the loading and unloading procedures of the cylindrical bales.

It is yet further desirable to provide a cylindrical bale trailer capable of maintaining a level orientation when loading, unloading and/or transporting the cylindrical bales, thereby eliminating any longitudinal imbalance likely to occur when just one or two bales would be picked up by the cylindrical bale trailer.

It is yet further desirable to provide a cylindrical bale trailer resistant to bending or breaking due to extreme force exerted by any sway motion of the cylindrical bales during transport.

### SUMMARY OF THE INVENTION

In general, the invention relates to a cylindrical bale trailer for transporting cylindrical bales from one location to another using a prime mover. The trailer includes a pair of substantially parallel, elongate side frame rails, with the side frame rails being spaced apart a distance less than the diameter of the cylindrical bale. Each of the side frame rails has a front terminal end and a rear terminal end, and each of the side frame rails is angled about the horizontal axis to maximize surface area contact between the cylindrical bales and the side frame rails. The trailer also includes a generally arcuate overhead axle secured substantially perpendicular to each of the side frame rails. Additionally, a front frame rail is secured substantially perpendicular to each of the side frame rails, with a hitch assembly attached to the front frame rail.

The hitch assembly is removably coupled to the prime mover. Further, the trailer includes a hydraulic lift assembly rigidly secured to each of the side frame rails intermediate of the front terminal end and the rear terminal end. The hydraulic lift assembly is in fluid communication with a source of hydraulic fluid. Each of the hydraulic lift assemblies includes a hydraulic lift cylinder secured to a bell crank having an lower arm angularly disposed away from the side frame rail. The lower arm of the bell crank includes an axle and a wheel connected thereto, with the wheel having a positive camber angle with respect to the trailer.

The rear terminal end of each of the side frame rails may angularly disposed to aid during loading and unloading of the trailer. For example, the rear terminal end of each of the side frame rails may be outwardly angled by approximately sixteen (16) degrees and/or downwardly angled by approximately six (6) degrees. Further, each of the side frame rails may be angled about the horizontal axis by approximately forty-five (45) degrees.

The hitch assembly of the trailer may be a bumper pull hitch assembly or a gooseneck hitch assembly. The bumper pull hitch assembly can have a forwardly extending, triangularly-shaped support frame and a hitch beam. The hitch beam is substantially parallel to the side frame rails, and a front terminal end of the hitch beam has a ball and socket hitch for removably coupling the trailer to the prime mover. In addition, the support frame may be attached to the front frame rail at an upwardly biased angle. The bumper pull hitch assembly could also include a hydraulically-actuated hitch beam and a hydraulic cylinder. The hydraulically-actuated hitch beam has a trailer section pivotally secured to a prime mover section, with the trailer section of the hydraulically-actuated hitch beam having a ball and socket hitch secured thereto at an upwardly sloping angle. The hydraulic cylinder fluidly connects the source of hydraulic fluid to extended and contract a piston rod within the hydraulic cylinder in order to selectively raise and lower the trailer. Alternatively, the trailer may utilize the gooseneck hitch assembly having a hydraulic cylinder secured within a substantially vertically-aligned, hydraulic component housing. The hydraulic cylinder is fluidly connected to the source of hydraulic fluid to selectively extended and contract a piston rod within the hydraulic cylinder. The gooseneck hitch assembly can also include an upwardly extending, triangularly-shaped support frame attached to the front frame rail. The support frame has a forwardly extending, generally arcuate, hydraulic support beam, and a terminal end of the support beam has the hydraulic component housing attached thereto.

Each of the hydraulic lift assemblies of the trailer may include a substantially horizontal platform to which a terminal end of the overhead axle is rigidly secured. The platform would be rigidly secured to the side frame rails. Further, a hydraulic lift cylinder can be connected to the platform in a manner to allow the hydraulic lift cylinder to pivot with respect to the platform. The lower arm of the bell crank may be angularly disposed away from the side frame rail at an angle of approximately seventeen (17) degrees, and each of the wheels may have a positive camber angle of approximately one (1) degree with respect to the trailer. The bell crank can include an upper arm that is substantially parallel to the side frame rails, with the bell crank being substantially L-shaped with a pivot point where the lower arm and the upper arm join. The pivot point of the bell crank can be pivotally secured to a mounting bracket on a front section of each of the platforms, and the mounting bracket could have the positive camber angle with the wheel connected to the lower arm of the bell crank.

The trailer may also include a safety lockout valve in fluid communication with the source of hydraulic fluid to selectively adjust fluid volume within the hydraulic lift cylinders and to maintain fluid volume within the hydraulic lift cylinders in the event of a break or leak from the source of hydraulic fluid. Further, an equalizer value may be placed in fluid communication with the source of the hydraulic fluid and be fluidly connected intermediate of the hydraulic lift assemblies. The trailer can further include a pair of support legs removably securable to the side frame rails respectively intermediate of the front frame rail and the hydraulic lift assemblies. Lastly, the trailer may include opposing side protection plates respectively secured to each of the side frame rails and the overhead axle to provide protection against damage to the hydraulic lift assemblies during usage.

### BRIEF DESCRIPTION OF THE DRAWINGS

FIG. 1 is a perspective view of an example of a cylindrical bale trailer having a standard bumper hitch assembly in accordance with an illustrative embodiment of the cylindrical bale trailer disclosed herein;

FIG. 2 is a perspective view of an example of a standard bumper hitch assembly in accordance with an illustrative embodiment of the cylindrical bale trailer disclosed herein;

FIG. 3 is a front perspective view of the standard bumper hitch shown in FIG. 2;

FIG. 4 is a perspective view of an example of a gooseneck hitch assembly in accordance with an illustrative embodiment of the cylindrical bale trailer disclosed herein;

FIG. 5 is an enlarged perspective view of an example of a hydraulic lift assembly in accordance with an illustrative embodiment of the cylindrical bale trailer disclosed herein;

FIG. 6 is a bottom perspective view of the hydraulic lift assembly shown in FIG. 5;

FIG. 7 is a top perspective view of the hydraulic lift assembly shown in FIG. 5;

FIG. 8 is a front perspective view of the hydraulic lift assembly shown in FIG. 5;

FIG. 9 is an exploded perspective view of the hydraulic lift assembly shown in FIG. 5;

FIG. 10 is a side view of an example of a cylindrical bale trailer in a lowered position and attached to a prime mover using a standard bumper hitch assembly in accordance with an illustrative embodiment of the cylindrical bale trailer disclosed herein;

FIG. 11 is a side view of the cylindrical bale trailer shown in FIG. 10 in a raised position;

FIG. 12 is a side view of an example of a cylindrical bale trailer in a lowered position with support legs in contact with the ground in accordance with an illustrative embodiment of the cylindrical bale trailer disclosed herein;

FIG. 13 is a side view of another example of a cylindrical bale trailer in a lowered position and attached to a prime mover using a gooseneck hitch assembly in accordance with an illustrative embodiment of the cylindrical bale trailer disclosed herein;

FIG. 14 is a side view of the cylindrical bale trailer shown in FIG. 13 in a raised position;

FIG. 15 is a perspective view of another example of a gooseneck hitch assembly in accordance with an illustrative embodiment of the cylindrical bale trailer disclosed herein;

FIG. 16 is a cross-sectional view along line 16-16 of the cylindrical bale trailer shown in FIG. 15;

FIG. 17 is a side view of an example of cylindrical bale trailer in a lowered position and attached to a prime mover using a hydraulically-actuated bumper hitch assembly in accordance with an illustrative embodiment at the cylindrical bale trailer disclosed herein; and

FIG. 18 is a side view of the cylindrical bale trailer shown in FIG. 17 in a raised position.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the construction and the arrangement of the structural and function details disclosed herein without departing from the spirit and scope of this disclosure. It is understood that the devices and methods are not limited to the embodiments set forth herein for purposes of exemplification.

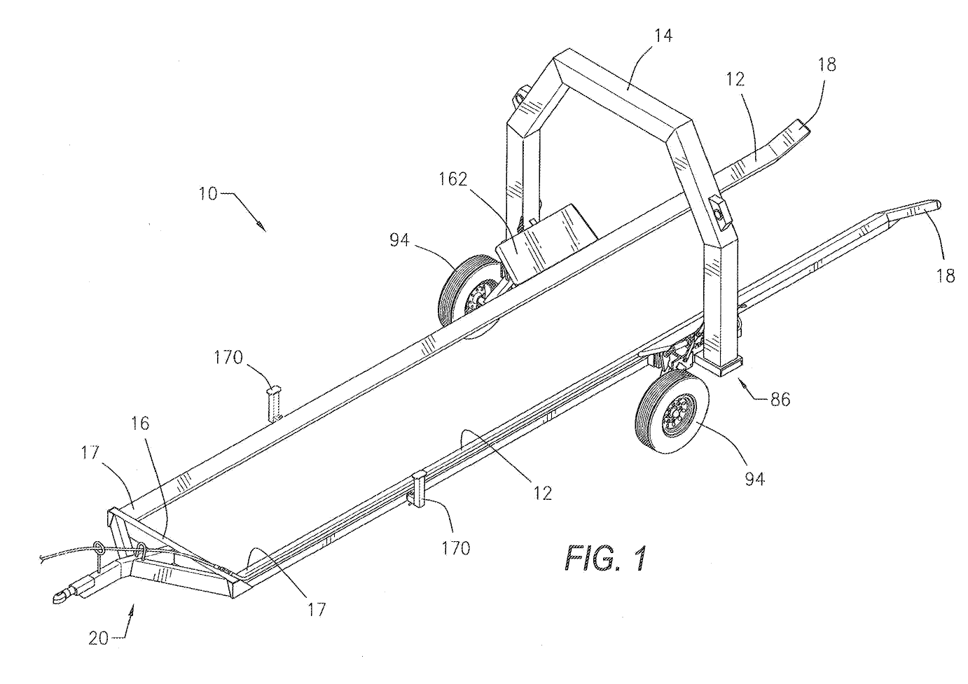

Referring to the figures of the drawings, wherein like numerals of reference designate like elements throughout the several views, and initially to FIG. 1, a cylindrical bale trailer 10 having a pair of substantially parallel, elongate side frame rails 12, a generally arcuate overhead axle 14 secured substantially perpendicular to the side frame rails 12, and a front frame rail 16 secured substantially perpendicular to the front terminal ends 17 of the side frame rails 12 and substantially parallel to the overhead axle 14. The overhead axle 14 and the front frame rail 16 are constructed to maintain the side frame rails 12 in a parallel relation during operation. Rear terminal ends 20 of the side frame rails 12 may be angularly disposed, such as outwardly angled by approximately sixteen (16) degrees and/or downwardly angled by approximately six (6) degrees, to aid during the loading and unloading procedures of cylindrical bales (not shown). Each of the side frame rails 12 may be angled about the horizontal axis by approximately forty-five (45) degrees to maximize the surface contact area between the cylindrical bales and the side frame rails 12. Generally, the width of the overhead axle 14 and the length of the front frame rail 16 will be such that the side frame rails 12 are more closely together than the diameter of the cylindrical bales, so that the cylindrical bales rest upon the top face of the side frame rails 12. The side frame rails 12 should be spaced apart a distance sufficient to permit the side frame rails 12 to slide easily alongside either side of the cylindrical bales while the cylindrical bale is resting on the ground.

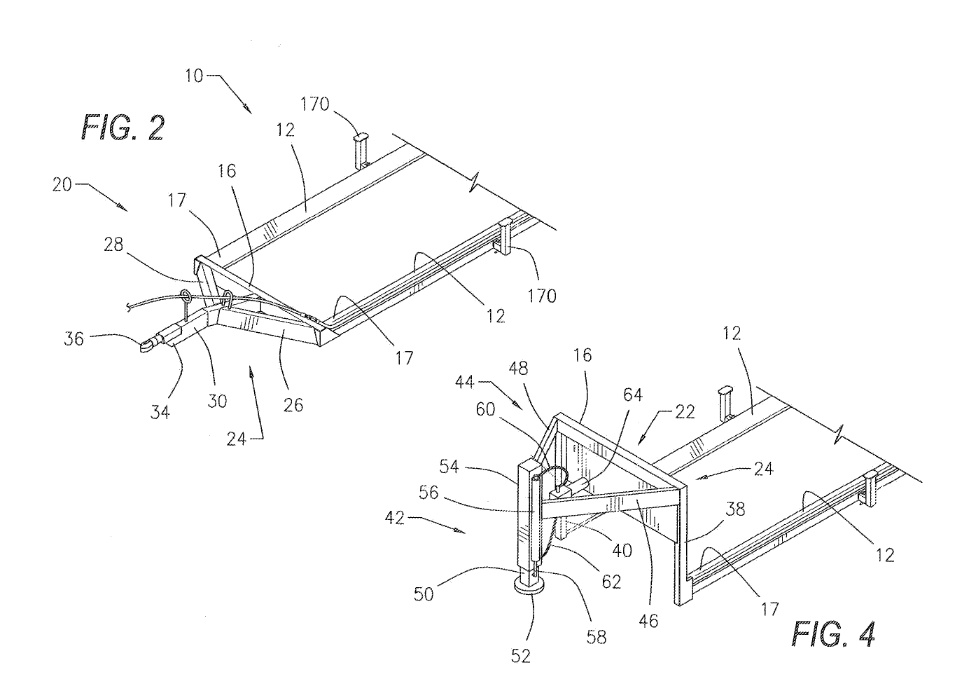

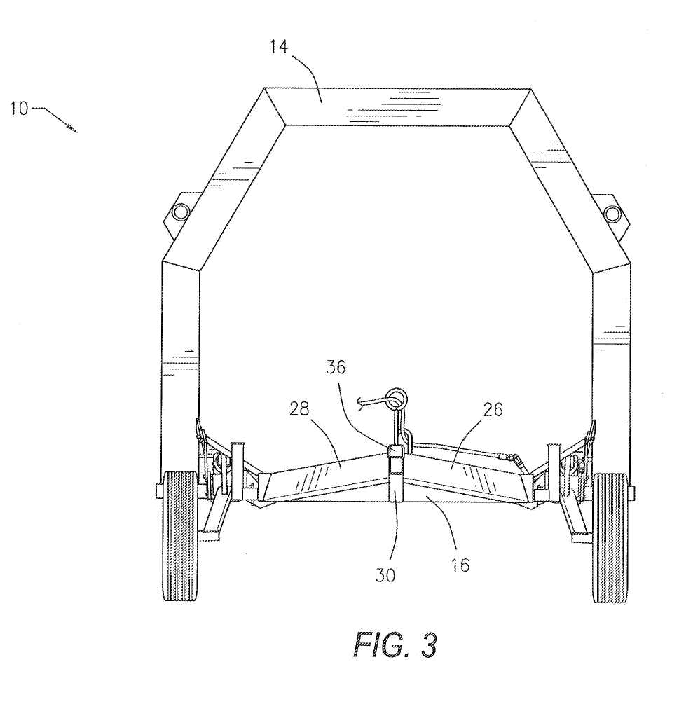

A hitch assembly is attached to the front frame rail 16. The hitch assembly may be a standard bumper pull hitch assembly 20 as shown in FIGS. 2 and 3, or a gooseneck hitch assembly 22 as shown in FIG. 4. As exemplified in FIGS. 1 and 2, the standard bumper pull hitch assembly 20 includes a forwardly extending, triangularly-shaped support frame 24, generally comprising beams 26 and 28 attached at respective ends to the front frame rail 16 and to a hitch beam 30. The front frame rail 16 has opposing terminal ends that are respectively secured to front terminal ends 17 of the side frame rails 12. As illustrated, the hitch beam 30 may be substantially parallel to the side frame rails 12 and is attached to the front frame rail 16 at a rear terminal end 32. A front terminal end 34 of the hitch beam 30 includes a ball and socket hitch 36. As illustrated in FIG. 2, the standard bumper pull hitch assembly 20 may be secured to the receiver front frame rail 16 at an upwardly biased angle.

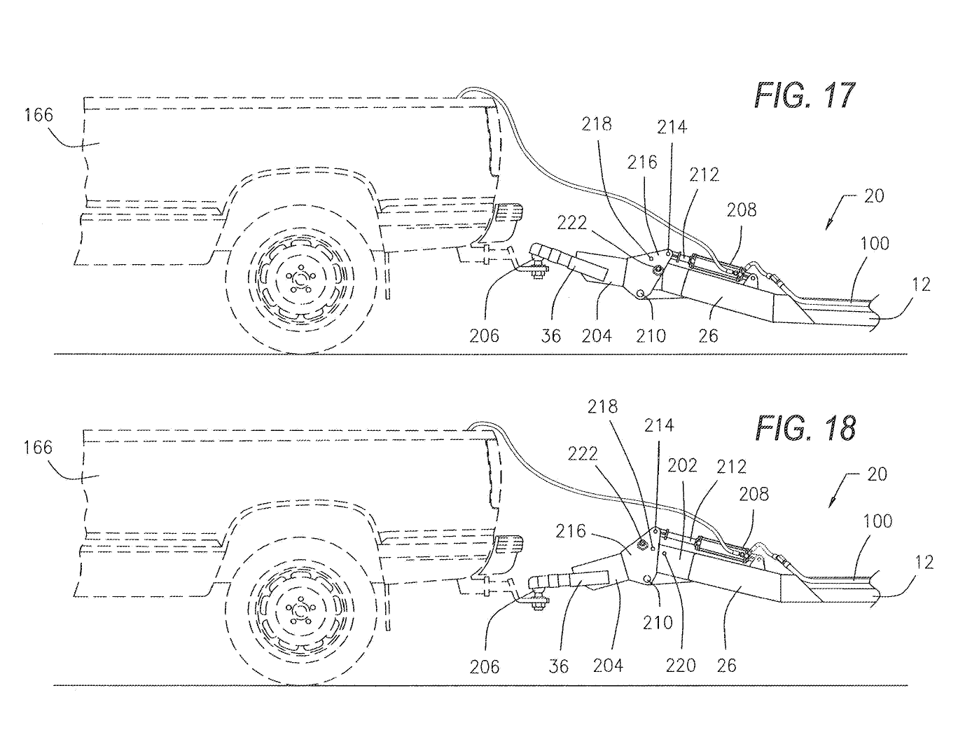

As exemplified in FIGS. 17 and 18, the bumper pull hitch assembly 20 may further include a hydraulically-actuated hitch beam 30. The hydraulically-actuated hitch beam 30 includes a trailer section 202, which may be substantially parallel to the beams 26 and 28, pivotally secured to a prime mover section 204, which has the ball and socket hitch 36 attached to the trailer section 202 at an upwardly sloping angle. This upward angle allows the ball and socket hitch 36 to fully engage a ball hitch 206 when the hydraulically-actuated hitch assembly 30 is in an extended/raised position exemplified in FIG. 18.

A hydraulic cylinder 208 is secured to the bumper pull hitch assembly 20 intermediate of the beams 26 and 28. The hydraulic cylinder 208 is aligned in parallel with the trailer section 202, the prime mover section 204, and the ball and socket hitch 36. The hydraulic cylinder 208 is in fluid communication with the main hydraulic line 100, whereby hydraulic fluid may be directed into the hydraulic cylinder 208 through the main hydraulic line 100. The hydraulic cylinder 208 can be a single-acting cylinder for a powered up and gravity actuated lowering action, or may be a double-acting cylinder for a powered up and down action.

The trailer section 202 of the hydraulically-actuated hitch beam 30 is pivotally secured to the prime mover section 204 along a hinge pin 210. The hydraulic cylinder 208 includes a piston rod 212 that is pivotally connected by a pin 214 intermediate of a pair of substantially parallel plates 216. Each of the plates 216 has a series of apertures 218 through which a locking pin 222 may be inserted in order to lock the hydraulically-actuated hitch beam 30 in position. The apertures 218 align with a pin aperture 220 in the trailer section 202.

During operation of the bumper pull hitch assembly 20 with the hydraulically-actuated hitch beam 30, when the hydraulic cylinder 208 is actuated using hydraulic fluid from the main hydraulic line 100, the piston rod 212 pushes the pin 214 causing the plates 216 to pivot along with the hinge pin 210. This pivoting action causes/allows the trailer 10 to be raised and lowered depending upon the particular circumstances, as illustrated between FIGS. 17 and 18. The upward angle at which the ball and socket hitch 36 is attached to the prime mover section 204 keeps the ball and socket hitch 36 in full engagement with the ball hitch 206 when the trailer 10 is raised from the lowered position shown in FIG. 17 to the upper position shown in FIG. 18.

Turning now to FIG. 4, the gooseneck hitch assembly 22 may include the front frame rail 16 secured to two substantially vertical, downwardly extending beams 38 and 40, the ends of which are secured, respectively, to the side frame rails 12. A hydraulic component 42 is secured to the gooseneck hitch assembly 22 via a forwardly extending, triangularly-shaped support frame 44, generally comprising beams 46 and 48 attached at respective ends to the front frame rail 16 and to the hydraulic component 42. The hydraulic component 42 includes a pair of close-fitting, slidably cooperative tube-like members, and more particularly, an inner tube-like member 50 secured to a coupling pin 52 and an outer tube-like member 54 secured to the support frame 44. A hydraulic cylinder 56 is secured to the outer tube-like member 54 with a piston rod 58 attached to the inner tube-like member 50 for raising and lowering the inner tube-like member 50 within the outer tube-like member 54. The hydraulic cylinder 56 is connected to a source of hydraulic fluid through suitable hydraulic lines 60 and 62, whereby fluid directed into the hydraulic cylinder 56 through one of the lines, such as the line 60, will extend the piston rod 58 and fluid directed into the hydraulic cylinder 56 through the other line, such as the line 110, will contract the piston rod 58 within the hydraulic cylinder 56.

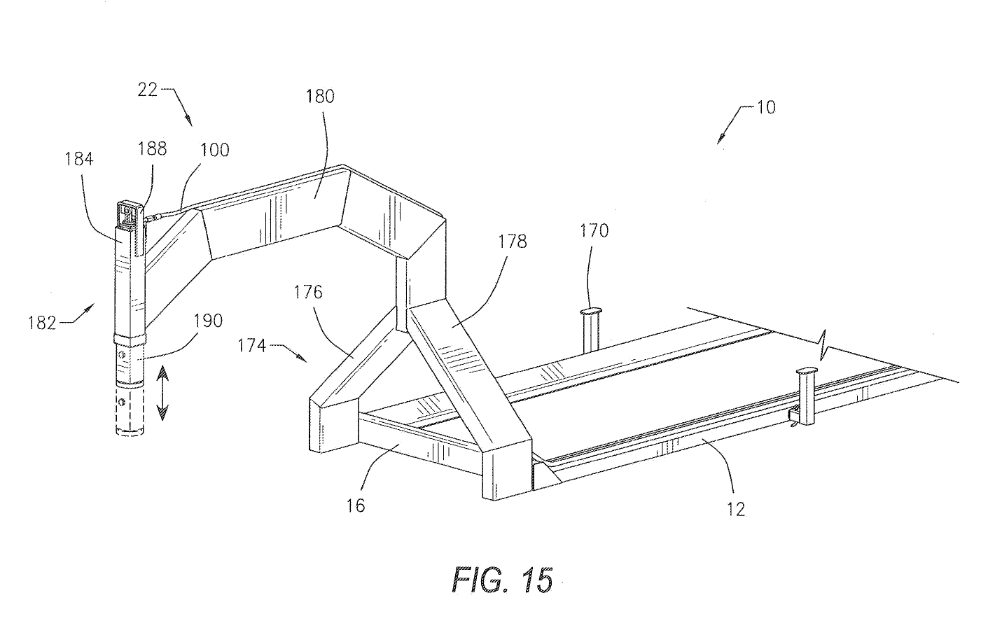

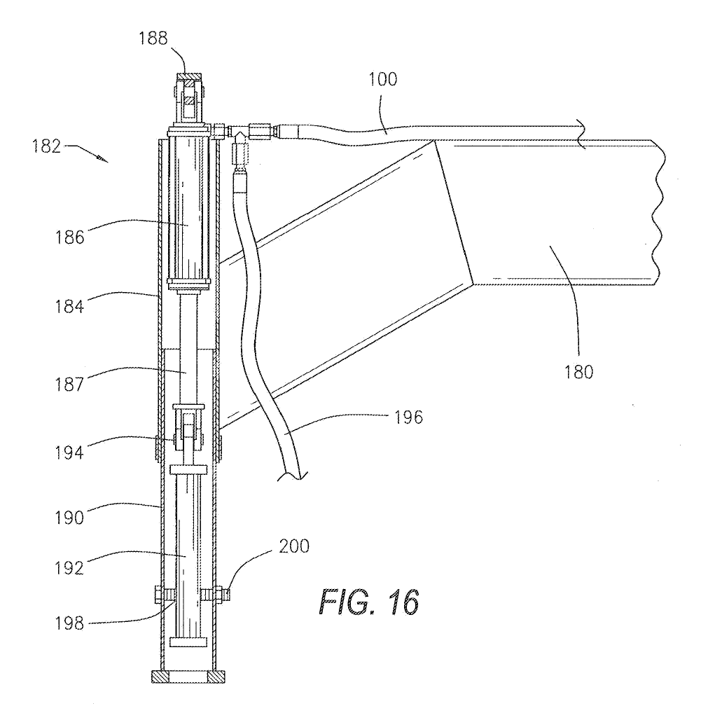

As exemplified in FIGS. 15 and 16, the gooseneck hitch assembly 22 may include the front frame rail 16 secured to an upwardly extending, triangularly-shaped support frame 174, generally comprising beams 176 and 178 attached at respective ends to the front frame rail 16 and to a forwardly extending, generally arcuate, hydraulic support beam 180. One terminal end of the hydraulic support beam 180 is attached to a corner of the triangularly-shaped support frame 174, while the other terminal end of the hydraulic support beam 180 is attached to a hydraulic component 182. The hydraulic component 182 includes an upper housing 184 having a hydraulic cylinder 186 secured therein via a generally U-shaped bracket 188 attached to an upper portion of the upper housing 184. A piston rod 187 of the hydraulic cylinder 186 is secured to a lower extender arm 192 via a pin 194. A lower portion of the lower extender arm 192 is attached to a lower housing 190, which is slidably engaged within the upper housing 184. The hydraulic cylinder 186 is connected to a source of hydraulic fluid through suitable hydraulic line 196, whereby fluid directed into the hydraulic cylinder 186 extends the piston rod 187 causing the lower extender arm 192 to extend the lower housing 184 of the hydraulic component 182. The lower extender arm 192 and the lower housing 184 may each include an axial bore 198 through which a pin 200 may be inserted in order to lock the lower housing 184 and the lower extender arm 192 in place.

The source of hydraulic fluid may be delivered from a hydraulic unit 64 that may be mounted to the gooseneck hitch assembly 22 or to a prime mover 66. The hydraulic cylinder 56 or 186 may be a single-acting hydraulic cylinder for a powered up and gravity actuated lowering action or a double-acting hydraulic cylinder for a powered up and down action. The hydraulic unit 64 may be controlled by suitable central controls.

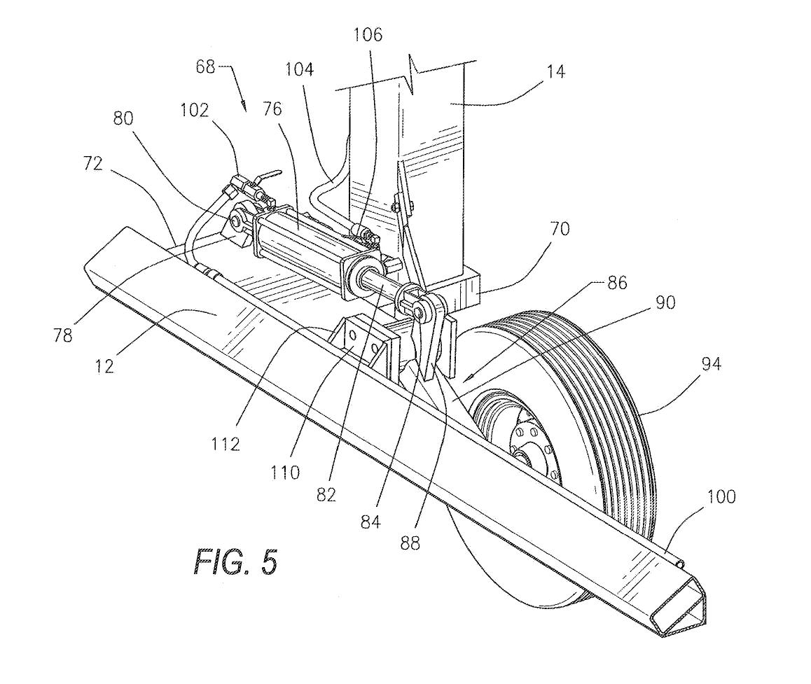

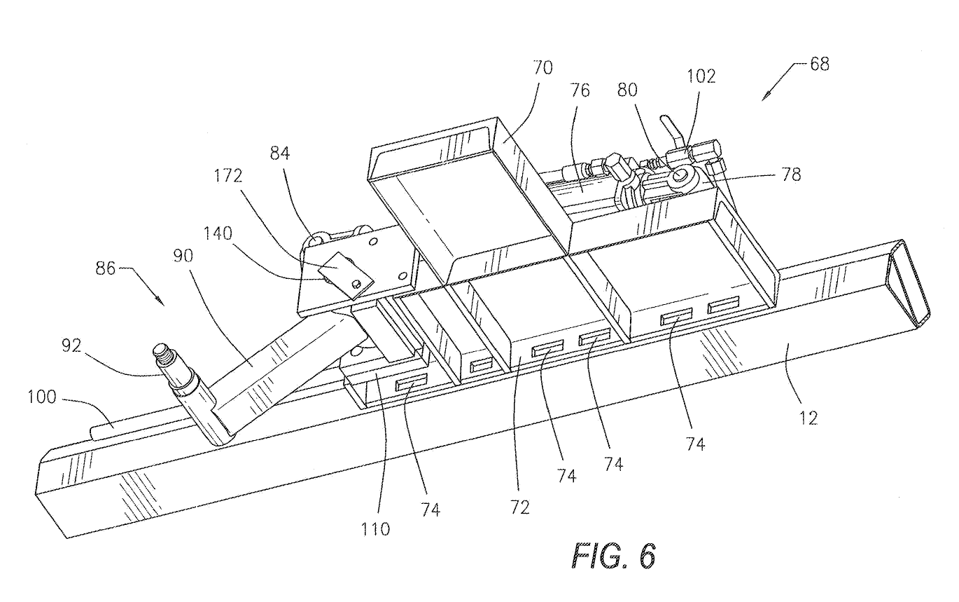

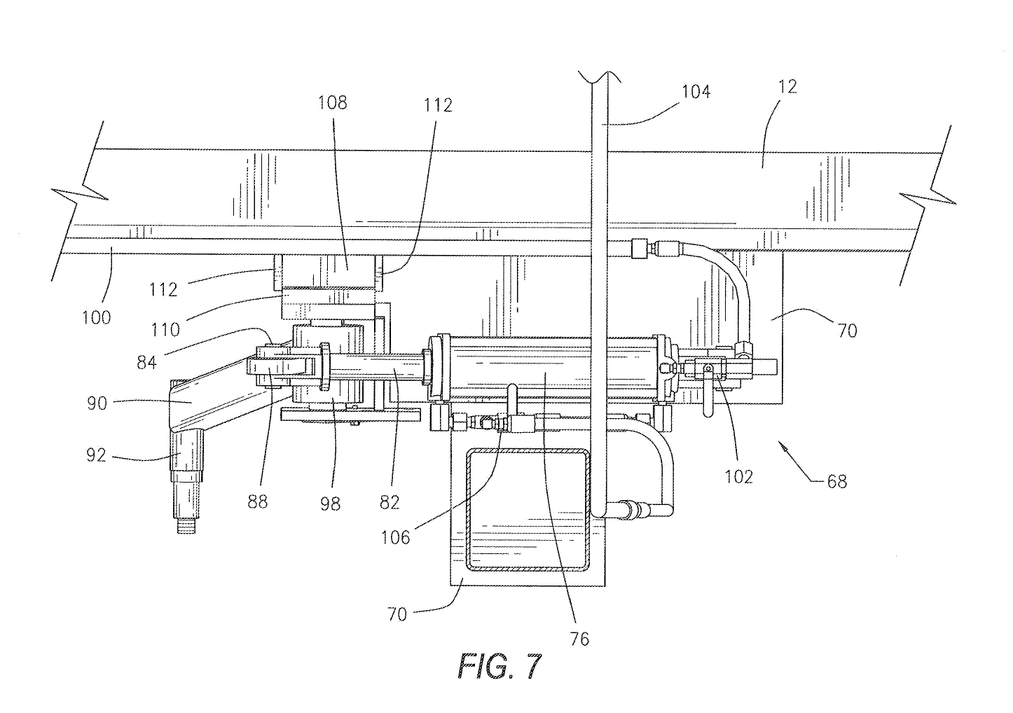

Referring now to FIGS. 5 through 9, the cylindrical bale trailer 10 further includes a hydraulic lift assembly 68 rigidly secured to each of the side frame rails 12, respectively, intermediate of the front terminal end 17 and the rear terminal end 18 thereof. As can be seen throughout the several views, the hydraulic lift assemblies 68 are mirror images of each other, with each hydraulic lift assembly 68 including a substantially horizontal platform 70 to which each terminal end of the overhead axle 14 is secured. The platform 70 may be constructed of structural steel, ship channel with an elongate vertical face 72 of the platform 70 being rigidly secured to the side frame rail 12; for example, the elongate vertical face 72 of the platform 70 may include a series of apertures 74 through which the platform is secured to the side frame rails 12, as illustrated in FIG. 6. A hydraulic lift cylinder 76 is connected to the platform 70 via a substantially vertical gudgeon 78 and pintle 80 to allow the hydraulic lift cylinder 76 to pivot with respect to the platform 70. The hydraulic lift cylinder 76 includes a piston rod 82 that is pivotally connected by a pin 84 to a bell crank 86 at a first arm 88 thereof. A second arm 90 of the bell crank 86 has an axle 92 to which a wheel 94 and brake assembly 96 is supported. The bell crank 86 is substantially L-shaped with a pivot point 98 where the first arm 88 and the second arm 90 join. The first arm 88 of the bell crank 86 is substantially parallel to the side frame rails 12, whereas the second arm 90 of the bell crank 86 is angularly disposed away from the respective side frame rail 12, such as at an angle of approximately seventeen (17) degrees.

The hydraulic lift cylinder 76 is in fluid communication with a source of hydraulic fluid via a main hydraulic line 100 secured to one of the side frame rails 12, whereby fluid is directed into the hydraulic lift cylinder 76 through the main hydraulic line 100. In fluid communication with the main hydraulic line 100 and the hydraulic lift cylinder 76 may be a safety lockout valve 102 in order to selectively adjust the amount of fluid volume within the hydraulic lift cylinder 76 and to maintain fluid volume within the hydraulic lift cylinder 76 in the event of a break or leak in the main hydraulic line 100 or a secondary hydraulic line 104. The secondary hydraulic line 104 is in fluid communication between the hydraulic lift cylinders 76 of the hydraulic lift assemblies 68, and may be routed along the overhead axle 14 as illustrated. The secondary hydraulic line 104 may also include an equalizer valve 106 enabling the amount of fluid pressure between the hydraulic lift cylinders 76 of the hydraulic lift assemblies 68 to be selectively adjusted. The hydraulic fluid directed to the hydraulic lift cylinders 76 of the hydraulic lift assemblies 68 will extend and contract the piston rods 82. During operation, when the hydraulic lift cylinders 76 are actuated, the piston rods 82 push the first arms 88 of the bell cranks 86, thereby rotating the bell cranks 86 about the pivot points 98, resulting in the second arms 90 of the bell cranks 86 simultaneously raising the wheels 94 in cooperation. When the hydraulic lift cylinders 76 are single-acting hydraulic cylinders, the wheels 94 are lowered in cooperation by gravity, while when the hydraulic lift cylinders 76 are double-acting hydraulic cylinders, the wheels are lowered by the piston rods 82 pulling the bell cranks 86, resulting in the lowering of the wheels 94.

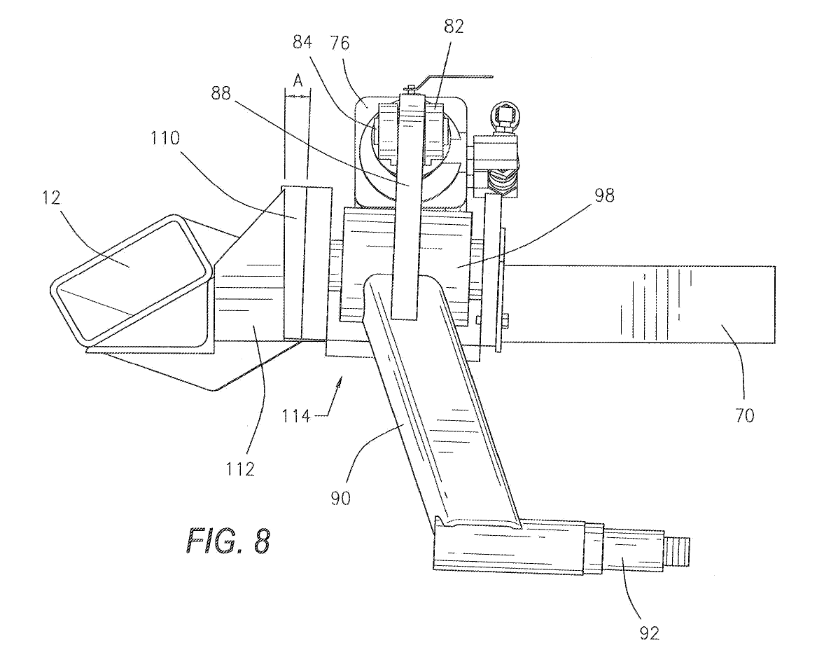

A front section 108 of each of the platforms 70 of the hydraulic lift assemblies 68 include an inner mounting plate 110 secured to the platform 70, such as by using a pair of substantially vertical gussets 112. The inner mounting plate 110 may be attached to the gussets 112 in such a manner that results in a positive camber angle A, as exemplified in FIG. 8, in order to achieve a lower trailing effort, add additional structural integrity to the lift assembly, and to reduce deflection when the cylindrical bale trailer 10 is loaded with cylindrical bales. For example, the bottom portion of the inner mounting plate 110 may be toed in by approximately ⅛ inch, resulting in a positive camber angle A of approximately one (1) degree.

A mounting bracket 114, to which the pivot point 98 of the bell crank 86 is pivotally secured, is secured to the inner mounting plate 100. The mounting bracket 114 includes an intermediate mounting plate 116 and an outer mounting plate 118. The mounting bracket 114 is secured to the inner mounting plate 110 such that the inner mounting plate 110, the intermediate mounting plate 116 and the outer mounting plate 118 are substantially upright and in substantially parallel alignment. The intermediate mounting plate 116 may be attached to the outer mounting plate 118 via a substantially vertical rear plate 120, which is substantially perpendicular to both the intermediate mounting plate 116 and the outer mounting plate 118, and a substantially horizontal bottom plate 122, which is also substantially perpendicular to the intermediate mounting plate 116 and the outer mounting plate 118. The inner mounting plate 110 and the intermediate mounting plate 116 may each have four (4) apertures 124 near the corners thereof. The apertures 124 of the inner mounting plate 110 and the intermediate mounting plate 116 are axially aligned, such that bolts 126 or other fastening mechanisms may be passed therethrough to secure the intermediate mounting plate 116 to the inner mounting plate 110. A rear portion 128 of the outer mounting plate 118 is attached to the platform 70, and a hinge arm 130 may be attached at opposing ends to the outer mounting plate 118 and the overhead axle 14.

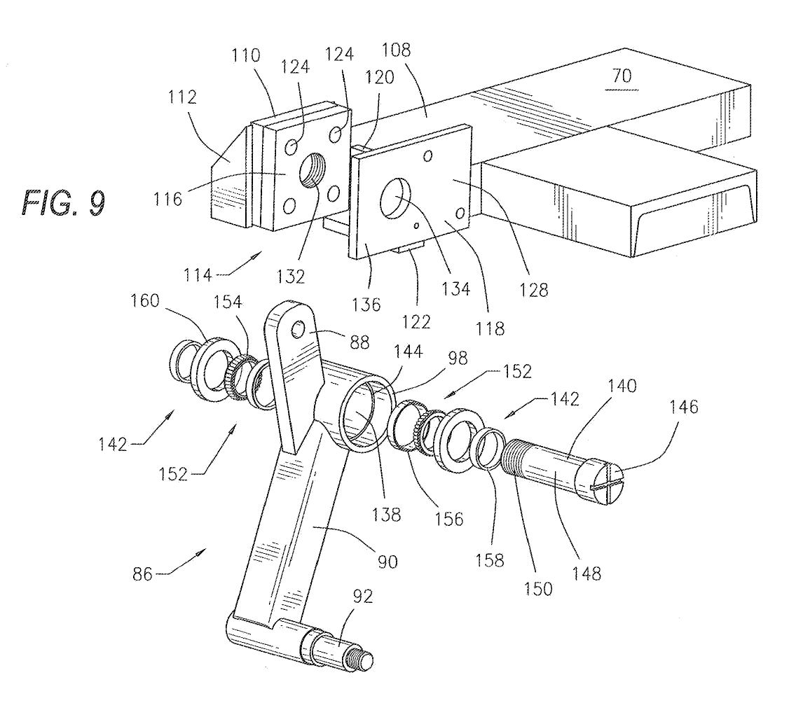

As can be seen from the exploded view of FIG. 9, the intermediate mounting plate 116 includes a central bore 132 having internal threads, and the outer mounting plate 118 has a bore 134 near a front portion 136 thereof. The pivot point 98 of the bell crank 86 includes a central bore 138 through which a spindle 140 and bearing assembly 142 is passed in order to pivotally connect the bell crank 86 to the mounting bracket 114. The internal diameter of the central bore 138 of the bell crank 86 is larger at the bore openings than at the center portion of the bore, thereby forming opposing shoulders 144 upon which the bearing assembly 142 makes contact. The spindle 140 includes an enlarged driven head 146 having and an elongate body 148 terminating with an exteriorly threaded end 150. The bearing assembly 142 may include a rolling-element bearing 152 having a set of bearings 154 and races 156. The races 156 of the rolling-element bearing 152 respectively contact the shoulders 144 within the central bore 138 of the bell crank 86. A groove of the race 156 contacts the bearing 134, and the rolling-element bearing assembly 152 may also include a set of spacers 158 and seals 160. As illustrated, the spindle 140, the rolling-element bearing assembly 152 and the central bore 138 of the pivot point 98 of the bell crank 86 are axially spaced and coaxially aligned. The threaded end 150 of the spindle 140 is threadably engaged with the internal threads of the central bore 132 of the intermediate mounting plate 116 with the enlarged head 146 of the spindle 140 being received in the bore 134 of the outer mounting plate 118. During operation, the spindle 140 and the rolling-element bearing assembly 152 supports both the radial and axial loads of the cylindrical bale trailer 10 when loaded with cylindrical bales. Also during operation and as can be seen from FIG. 6, a set plate 172, which is secured to the outer mounting plate 118, mates with the driven head 146 of the spindle 140 such that the set plate 172 prevents any rotation of the spindle 140, thereby maintaining the threaded engagement between the exteriorly threaded end 150 of the spindle 140 and the central bore 132 of the intermediate mounting plate 116.

As previously discussed, the second arm 90 of the bell crank 86 has an axle 92 to which the wheel 94 brake and brake assembly 96 is supported. The brake assembly 96 can be any type of conventional brake, such as power disc brakes, electric drum brakes or hub brakes. Similar to the rolling-element bearing assembly 152 for pivotally securing the bell crank 86 to the mounting bracket 114, the brake assembly 96 may include a rolling-element bearing assembly 152 or other suitable bearing assembly.

Returning briefly to FIG. 1, the cylindrical bale trailer 10 may include opposing side plates 162, respectively, secured to the side frame rails 12 and the overhead axle 14. The side plates 162 provide protection against damage to the hydraulic lift assemblies 68. In addition, the cylindrical bale trailer 10 may include break lights 164, such as on the overhead axle 14 as exemplified in FIG. 1.

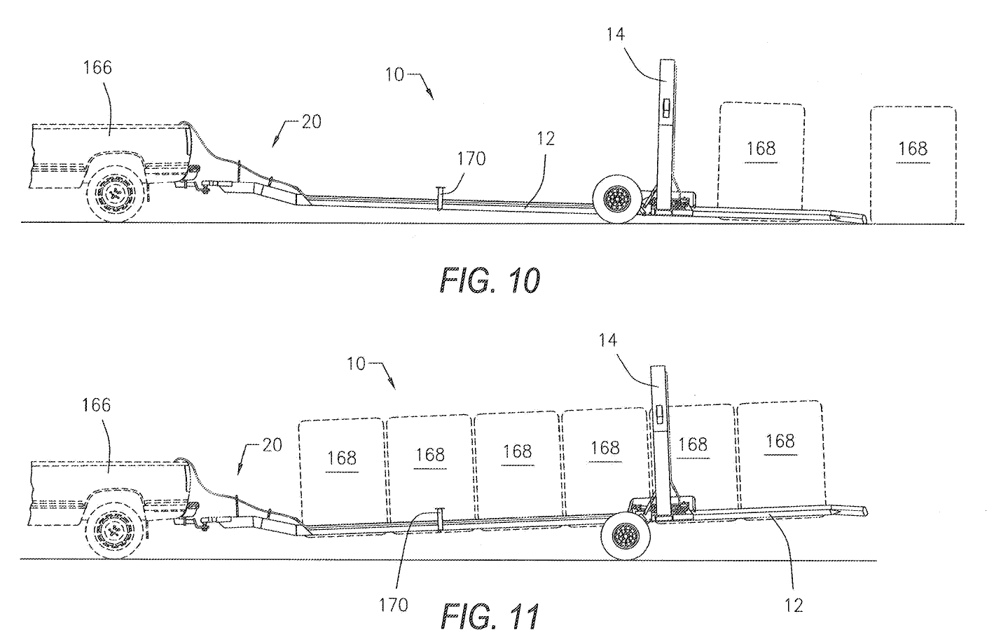

Referring now to FIGS. 10 through 14, the cylindrical bale trailer 10 is secured to a prime mover 166. The hydraulic lift assemblies 68 are hydraulically operated using the hydraulic lift cylinders 76 for moving the bell cranks 86 to raise and lower the side frame rails 12 of the cylindrical bale trailer 10 for loading and unloading cylindrical bales 168. In particular, the side frame rails 12 are raised and lowered upon the wheels 94 by the action of the hydraulic lift cylinders 76 by reason of the hydraulic fluid energy supplied through the hydraulic lines 100 and 104, which received pressurized hydraulic fluid from a source of hydraulic fluid.

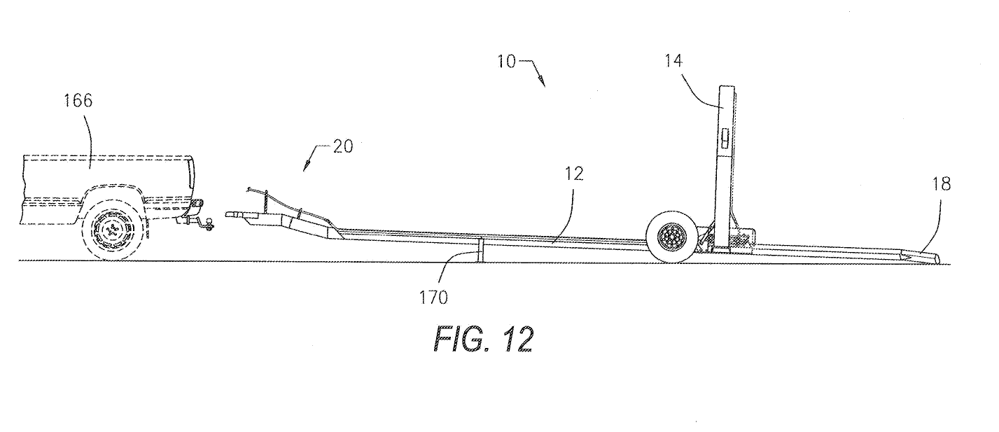

As illustrated in FIGS. 10 and 11, the cylindrical bale trailer 10 is secured to the prime mover 166 via the standard bumper hitch assembly 20 having a ball and socket hitch receiver 36. As the hydraulic lift cylinders 76 of the hydraulic lift assemblies 68 are actuated, the cylindrical bale trailer 10 pivots upwardly to transport cylindrical bales 168 or pivots downwardly at the rear terminal end 18 to load or unload cylindrical bales 168 from the side frame rails 12. As can be seen from FIG. 12, the cylindrical bale trailer 10 may include a pair of support legs 170 removably securable to the side frame rails 12, respectively, intermediate of the standard bumper hitch assembly 20 and the hydraulic lift assemblies 68. The support legs 170 may include a bore through which a locking pin may be inserted and secured. The support legs 170 when in a lowered position aid in removal of the cylindrical bale trailer 10 from the prime mover 166. The cylindrical bale trailer 10 may be lowered such that the support legs 170 contact the ground, causing the standard bumper hitch assembly 20 to disengage the prime mover 166. During operation, the support legs 170 may be placed in a raised position, as illustrated in FIG. 1, so that they do not interfere with the operation of the cylindrical bale trailer 10.

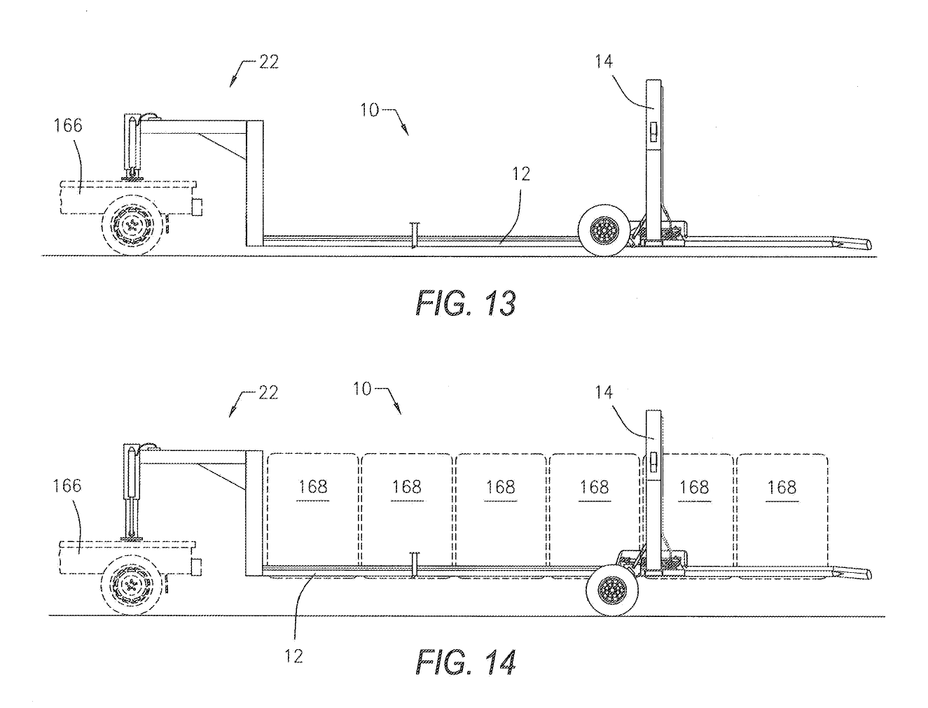

As illustrated in FIGS. 13 and 14, the cylindrical bale trailer 10 is secured to the prime mover via the gooseneck hitch assembly 22. As can be seen, the hydraulic component 42 in cooperation with the actuation of the hydraulic lift assemblies 68 cause the side frame rails to raise and lower in a substantially horizontal manner.

Whereas, the devices and methods have been described in relation to the drawings and claims, it should be understood that other and further modifications, apart from those shown or suggested herein, may be made within the spirit and scope of this invention.

What is claimed is:

1. A cylindrical bale trailer for transporting cylindrical bales from one location to another using a prime mover, said trailer comprising:
a pair of substantially parallel, elongate side frame rails, said side frame rails being spaced apart a distance less than the diameter of said cylindrical bale, each of said side frame rails having a front terminal end and a rear terminal end, each of said side frame rails being angled about the horizontal axis to maximize surface area contact between said cylindrical bales and said side frame rails;
a generally arcuate overhead axle secured substantially perpendicular to each of said side frame rails;
a front frame rail secured substantially perpendicular to each of said side frame rails,
a hitch assembly attached to said front frame rail, and said hitch assembly being removably coupled to said prime mover; and
a hydraulic lift assembly rigidly secured to each of said side frame rails intermediate of said front terminal end and said rear terminal end, said hydraulic lift assembly in fluid communication with a source of hydraulic fluid, each of said hydraulic lift assemblies comprising:
a hydraulic lift cylinder secured to a bell crank having a lower arm angularly disposed away from said side frame rail;
said lower arm of said bell crank having an axle and a wheel connected thereto; and
said wheel having a positive camber angle with respect to said trailer.

2. The trailer of claim 1 wherein said rear terminal end of each of said side frame rails is angularly disposed to aid during loading and unloading of said trailer.

3. The trailer of claim 2 wherein said rear terminal end of each of said side frame rails is outwardly angled by approximately sixteen (16) degrees and/or downwardly angled by approximately six (6) degrees.

4. The trailer of claim 1 wherein each of said side frame rails is angled about the horizontal axis by approximately forty-five (45) degrees.

5. The trailer of claim 1 wherein said hitch assembly is a bumper pull hitch assembly or a gooseneck hitch assembly.

6. The trailer of claim 5 wherein said bumper pull hitch assembly comprises a forwardly extending, triangularly-shaped support frame and a hitch beam; said hitch beam being substantially parallel to said side frame rails; and a front terminal end of said hitch beam having a ball and socket hitch for removably coupling said trailer to said prime mover.

7. The trailer of claim 6 wherein said support frame is attached to said front frame rail at an upwardly biased angle.

8. The trailer of claim 5 wherein said bumper pull hitch assembly further comprises a hydraulically-actuated hitch beam and a hydraulic cylinder; said hydraulically-actuated hitch beam having a trailer section pivotally secured to a prime mover section; said trailer section of said hydraulically-actuated hitch beam having a ball and socket hitch secured thereto at an upwardly sloping angle; and said hydraulic cylinder fluidly connected to said source of hydraulic fluid to extended and contract a piston rod within said hydraulic cylinder in order to selectively raise and lower said trailer.

9. The trailer of claim 5 wherein said gooseneck hitch assembly comprises a hydraulic cylinder secured within a substantially vertically-aligned, hydraulic component housing; and said hydraulic cylinder fluidly connected to said source of hydraulic fluid to selectively extended and contract a piston rod within said hydraulic cylinder.

10. The trailer of claim 9 wherein said gooseneck hitch assembly further comprises an upwardly extending, triangularly-shaped support frame attached to said front frame rail; said support frame comprising a forwardly extending, generally arcuate, hydraulic support beam; and a terminal end of said support beam having said hydraulic component housing attached thereto.

11. The trailer of claim 1 wherein each of said hydraulic lift assemblies includes a substantially horizontal platform to which a terminal end of said overhead axle is rigidly secured; and said platform rigidly secured to the side frame rails.

12. The trailer of claim 11 further comprising a hydraulic lift cylinder connected to said platform in a manner to allow said hydraulic lift cylinder to pivot with respect to said platform.

13. The trailer of claim 1 wherein said lower arm of said bell crank is angularly disposed away from said side frame rail at an angle of approximately seventeen (17) degrees.

14. The trailer of claim 1 wherein each of said wheels has a positive camber angle of approximately one (1) degree with respect to said trailer.

15. The trailer of claim 1 wherein said bell crank includes an upper arm that is substantially parallel to said side frame rails; and wherein said bell crank is substantially L-shaped with a pivot point where said lower arm and said upper arm join.

16. The trailer of claim 1 further comprising a safety lockout valve in fluid communication with said source of hydraulic fluid to selectively adjust fluid volume within said hydraulic lift cylinders and to maintain fluid volume within said hydraulic lift cylinders in the event of a break or leak from said source of hydraulic fluid.

17. The trailer of claim 1 further comprising an equalizer value in fluid communication with said source of said hydraulic fluid and being fluidly connected intermediate of said hydraulic lift assemblies.

18. The trailer of claim 11 wherein said pivot point of said bell crank is pivotally secured to a mounting bracket on a front section of each of said platforms, and said mounting bracket having said positive camber angle with said wheel connected to said lower arm of said bell crank.

19. The trailer of claim 1 further comprising opposing side protection plates respectively secured to each of said side frame rails and said overhead axle to provide protection against damage to said hydraulic lift assemblies during usage.

20. The trailer of claim 1 further comprising a pair of support legs removably securable to said side frame rails respectively intermediate of said front frame rail and said hydraulic lift assemblies.
